(19) United States
(12) Patent Application Publication
(10) Pub. No.: US 2015/0127850 A1
(43) Pub. Date: May 7, 2015

(54) COMMUNICATION LAYER STRUCTURE FOR COMPUTING DEVICE COMMUNICATION

(71) Applicant: ASELSAN Elektronik Sanayi ve Ticaret Anonim Sirketi, Ankara (TR)

(72) Inventors: Tanin Afacan, Ankara (TR); Özgür Basol, Ankara (TR); Ibrahim Karaaslan, Ankara (TR); Emrah Demircan, Ankara (TR); Erman Zaim, Ankara (TR)

(73) Assignee: ASELSAN Elektronik Sanayi ve Ticaret Anonim Sirketi, Ankara (TR)

(21) Appl. No.: 14/073,074

(22) Filed: Nov. 6, 2013

(51) Int. Cl. H04L 29/06; H04L 12/863

(52) U.S. Cl. CPC H04L 29/06163; H04L 47/6295; H04L 29/06129
USPC 709/237

(57) ABSTRACT

This invention discloses a Layer Architecture (LA) and its method of implementation. The Layer Architecture can be used in layered network communications between devices. The structure can be used in a network as one of the network layers within the network structure wherein two or more devices communicate via the network.

### BACKGROUND

Network communication between computers is used for information exchange between different devices and humans. System architecture considers dividing complex systems to interrelated smaller parts and constructing the whole system easily shows up with the relations of the parts. Architectural decisions are the design decisions that concern the whole system or one or more core parts. These decisions influence system quality issues. Typical quality characteristics are portability, maintainability and adaptability. Architectural decisions are very important due to the direct or indirect effect of non-functional requirements such as software quality characteristics. Therefore, designers should also consider the possible side effects of architectural decisions.

### SUMMARY OF THE INVENTION

This invention discloses a Layer Architecture (LA) and its method of implementation.

One object of the invention is to create a generic and modular layer architecture that can be used in layered network communications between devices.

Another object of the invention is to create a structure where one can use it and adapt it in a network as one of the network layers within the network structure wherein two or more devices communicate via the network.

Another object of the invention is to deploy a non-transitory computer-readable medium having embodied thereon a computer program configured to cause a processor to communicate between two endpoints connected to a network;
wherein the non-transitory computer-readable medium comprising one or more code segments configured the processor to have a first layer to send information to a communication layer identifying services provided to the communication layer; to have a second layer to send information to a communication layer identifying services provided to the communication layer; to have a layer manager unit in the communication layer to send information to a layer configuration parameters unit;
to have the layer manager unit in the communication unit to receive information from a protocol manager; to have the layer manager unit to send information to a layer monitor unit; and to have the layer manager to send information to the second layer.

### BRIEF DESCRIPTION OF THE DRAWINGS

FIG. 1 shows the network architecture

FIG. 2 shows the structure for the network layer

FIG. 3 shows the structure for the transport layer

FIG. 4 shows the structure for the transport layer

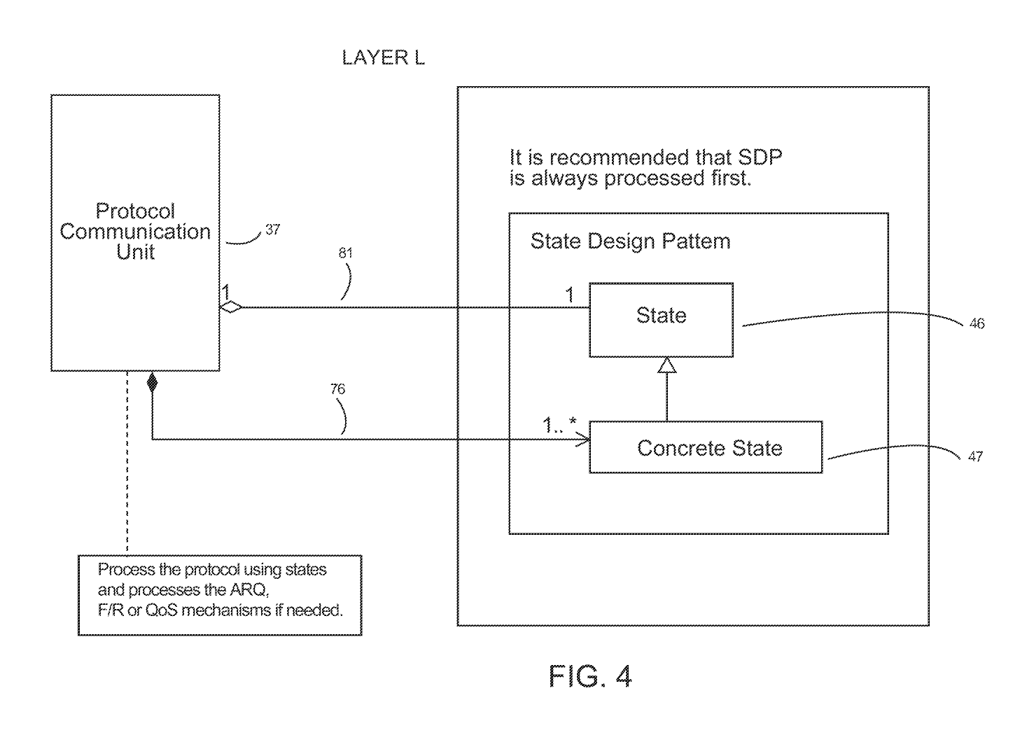

FIG. 5 shows the structure being used as the transport layer

FIG. 6 shows the details of the method used

FIG. 7 shows the details of the method used

FIG. 8 shows the details of the method used

FIG. 9 shows the details of the method used

### DETAILED DESCRIPTION OF PREFERRED EMBODIMENTS

Communications layers are defined by Open System Interconnection (OSI) to divide a complex task to several simpler pieces with piece having a certain function. It is a conceptual “Seven Layer Reference Model” describing the handling and transmission of data between networking devices. Alternatively, TCP/IP is a “Four Layer Reference Model” which is originally developed by The Defense Advance Research Projects Agency (DARPA) to interconnect defense networks.

Main difference between TCP/IP and OSI model is the lack of the definition of the communication layer protocols on OSI. Common output of each model is the usage of communication layer concept, however, TCPTP model is widespread in practice.

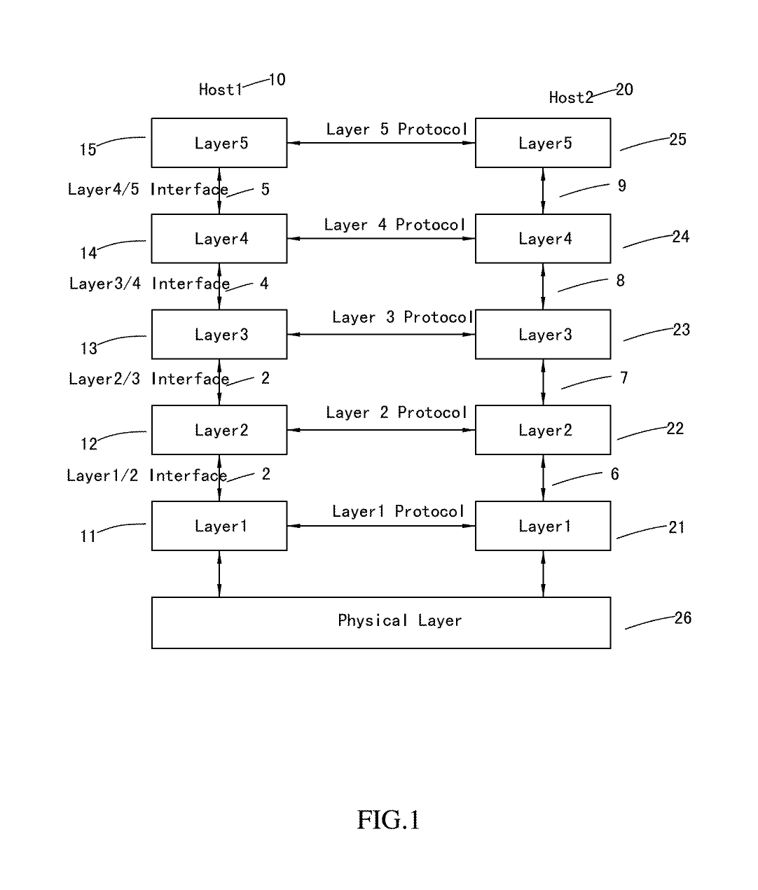

FIG. 1 shows different layers used in a network connection. The entities comprising the corresponding layers on different machines are called peers. The peers may be processes, hardware devices, or even human beings. Peers communicate with each other through an accepted protocol on each layer of the model. In reality, no data are directly transferred from layer “n” on one machine to layer “n” on another machine. Instead, each layer passes data and control information to the layer immediately below it, until the lowest layer is reached. Below layer 1 is the physical medium through which actual communication occurs. In FIG. 1, virtual communication is shown by dotted lines and physical communication by solid lines.

Communication layers may consist of one or several protocols which are standardized by organizations such as ETSI, ANSI, ITU and IETF. Protocol is a set of standardized rules and sometimes a protocol may be used interchangeably with the corresponding layer. Protocols and layers have some common features as follows:
They communicate with peers through interchange of messages or packets which may contain control or data.
They provide connection oriented or connectionless services.
They use packet or circuit network switching methods.
They have some configuration parameters.
They have some interfaces to use or to provide services.
They may have one or several states to act the events appropriately.
They may provide some level of QOS issues such as prioritization, delay, throughput, reliability.
They may support message fragmentation or reassembly.
They may support services such as congestion control or flow control.
They may support some mechanisms such as Automatic Repeat Request (ARQ), integrity control, error detection and correction.

The above general rules, requirements and features shall be used for the design and implementation of the layer and the layer protocols which form communication software.

LA is an object oriented architecture which is used to design and implement communication layers and protocols. It proposes a generic and a modular structure for the communication layers. In this architecture, forenamed common features of communication layers and protocols are included. Therefore, LA is a layer or a protocol design model. LA aims to provide the quality characteristics such as maintainability, adaptability and efficiency. Additionally, it takes into account the results and the possible side effects of architectural decisions.

Object oriented modeling techniques are used While designing the LA.

Designers can port and adapt the LA to new platforms easily. LA is useful in terms of understandability and learnability for the designers. LA is maintainable in terms of analyzability, changeability and testability for colleagues such as Test or System Engineering staff. Therefore, LA provides the quality characteristics such as usability, maintainability and portability.

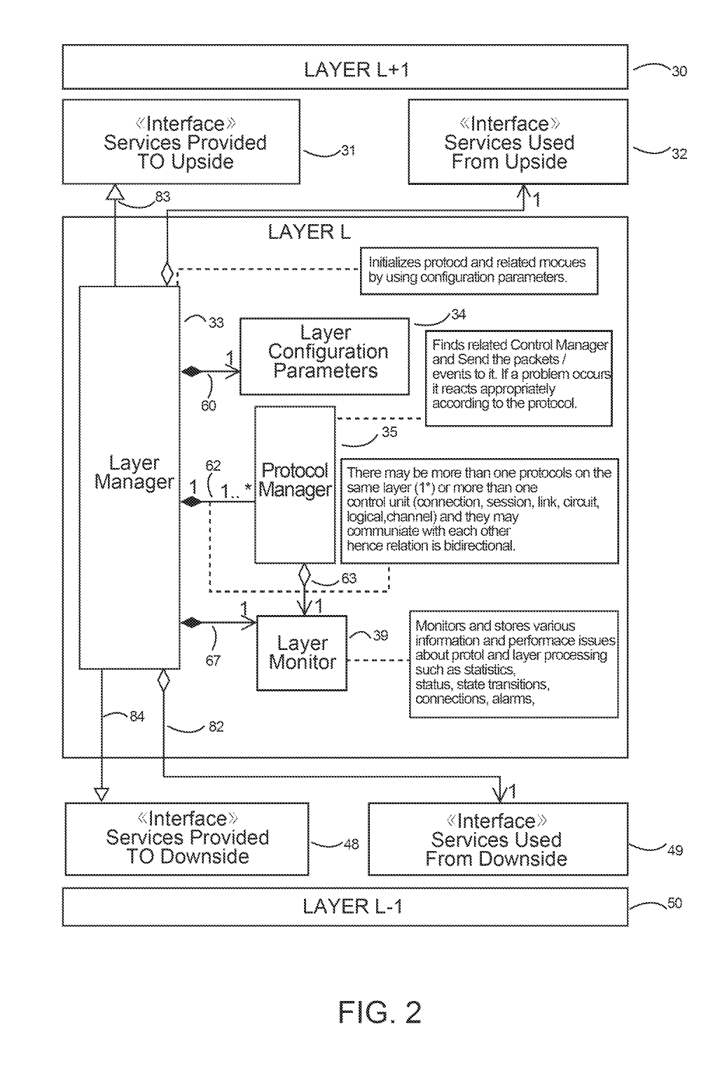

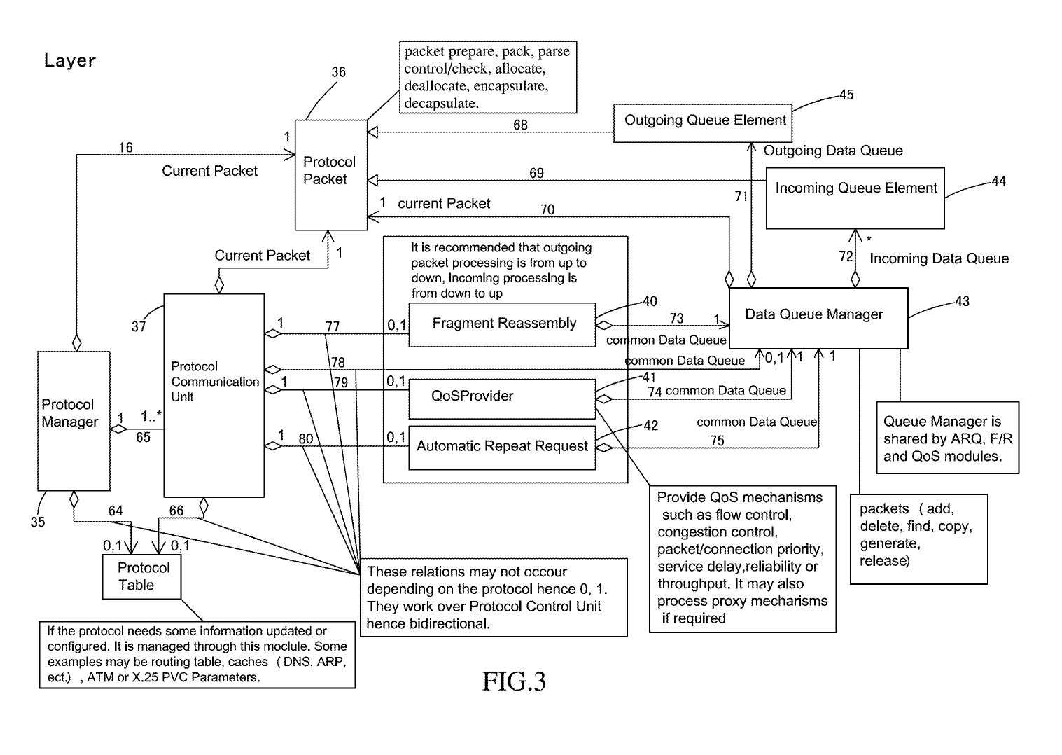

FIG. 3 shows the structure of LA. This structure can be applied to any layer of the network. LA may comprise one or more Protocol Communication Unit 37. Protocol Communication Unit 37 manages the connection, session, circuit, and logical channel functions. In FIG. 2 services provided to upside unit 31 contains the information of the services provided to upside unit 30. Services provided to upside unit 31 gets the list of information of services provided to upside unit from layer manager 33. Layer manager 33 also communicates with services used from upside unit 32. This way, layer manager 33 has access to the list of services provided by services used from upside unit 30.

Layer configuration parameters are stored in layer configuration parameters unit 34. Layer manager unit 33 accesses the layer configuration parameters by communicating with layer configuration parameters unit 34. Layer manager initializes protocol by using the configuration parameters received from Layer Configuration Parameters Unit 34. Protocol Manager 35 provides management function to follow a predetermined protocol. These functions include finding related control manager and sending packets and events to the identified control manager, Protocol Manager 35 handles any error conditions based on the current protocol.

Protocol Manager 35 controls the currently received packet and directs it to the related communication unit if needed, and reports the incoming information from the communication units to the monitor unit which it owns. If stated in the Standard, protocol manager 35 processes the protocol using one or more states according to the events.

Protocol Manager Unit 35 communicates with Protocol Packet Unit 36 that prepares packets, parses packets, controls and checks packets, allocate packets, de-allocate packets, encapsulate packets and de-capsulate packets. Protocol Packet Unit 36 receives packets 70 from Data Queue Manager Unit 43. Data Queue Manager Unit 43 processes the currently received protocol packet and communicates with Outgoing Queue Unit 45 and Incoming Queue Unit 44. Outgoing Queue Unit 45 stores outgoing protocol packets. Incoming Queue Unit 44 stores incoming protocol packets. Data Queue Manager Unit 43 has connection with Fragment Reassembly Unit 40, QoS Provider Unit 41 and Automatic Repeat Request Unit 42. QoS Provider Unit 41 provides QoS mechanisms such as flow control, congestion control, packet priority, connection priority, service delay, reliability or throughput. QoS Provider Unit 41 may also process proxy mechanisms if required.

Fragmented Reassembly Unit 40 fragments big packets coming from upper layer and reassemble protocol packets coming from lower layer if required. Fragment Reassembly Unit 40 communicates with Protocol Communication Unit 37 by connection 77. Connection 77 between Fragmented Reassembly Unit 40 and Protocol Communication Unit 37 may or may not be used depending upon the protocol used. Some protocols may use this communication while others may not require this communication. Therefore connection 77 is a protocol dependent connection.

Protocol Communication Unit 37 controls the currently received packet and directs it to the related communication unit if needed, and reports the incoming information from the communication units to the monitor unit which it owns. Protocol Communication Unit 37 processes the protocol using one or more states according to the events, if stated in the used standard. Protocol Communication Unit 37 communicates with Protocol Table 38 which consists of information about the protocol. If defined on the Standard, it has one Quality Of Service (QoS) unit which provides related requirements. QoS Provider Unit 41 communicates with Protocol Communication Unit 37 by connection 79. Connection 79 between QoS Provider Unit 40 and Protocol Communication Unit 37 may or may not be used depending upon the protocol used. Some protocols may use this communication while others may not require this communication. Therefore connection 79 is a protocol dependent connection.

Automatic Repeat Request Unit 42 provides reliable packet transmission and communicates with Protocol Communication Unit 37 by connection 80. Communication 80 between Automatic Repeat Request Unit 42 and Protocol Communication Unit 37 may or may not be used depending upon the protocol used. Some protocols may use this communication while others may not require this communication. Therefore connect on 80 is a protocol dependent connection.

State Design Pattern Unit 200 comprises State Unit 46 and Concrete State Unit 47. Protocol Communication Unit 37 processes the State Design Pattern Unit for each triggered event. State Design Pattern Unit 200 allows the Protocol Communication Unit 37 to manage internal communication states and alter its behavior to the events when its internal state changes. State Design Pattern Unit 200 includes Concrete State Unit 47 for each of the communication states. Each Concrete State Unit 47 determines the behavior to the events and the next state. State Unit 46 is a base class for all Concrete State Units 47 and it processes the common events which are not state specific.

Protocol Table Unit 38 helps with updating and configuring protocol information if such an update is needed. Protocol Table Unit 38 is connected to Protocol Manager Unit 35 and Protocol Communication Unit 37. Protocol Table Unit 38 includes static or dynamic protocol parameters such as routing table, caches (DNS, ARP, etc.), ATM or X.25 PVC table, protocol configuration parameters etc. Protocol Manager Unit 35 and Protocol Communication Unit 37 use the Protocol Table Unit 38 to manage the protocol parameters through the operations such as get and set.

Layer Monitor Unit 39 monitors and stores various information and performance related information about the protocol used. Layer Monitor Unit 39 also performs processing of statistics for the layer, status, state transitions, connections and alarms. Layer Monitor 39 is connected to Protocol Manager 35. Layer Manager Unit 33 and Protocol Manager Unit 35 both use Layer Monitor Unit 39 to store the information about the layer and layer protocols. Layer Monitor Unit 39 may send stored information to the out to debug and monitor the layer. Information may be about errors, alarms, counters, events, statistics and status of the units of the layer and layer protocols.

Fragment Reassembly (FR) unit 40 fragments big packets coming from upper layer and reassemble protocol packets coming from lower layer if required.

LA components, their relations and the direction of the relations are determined as defined above.

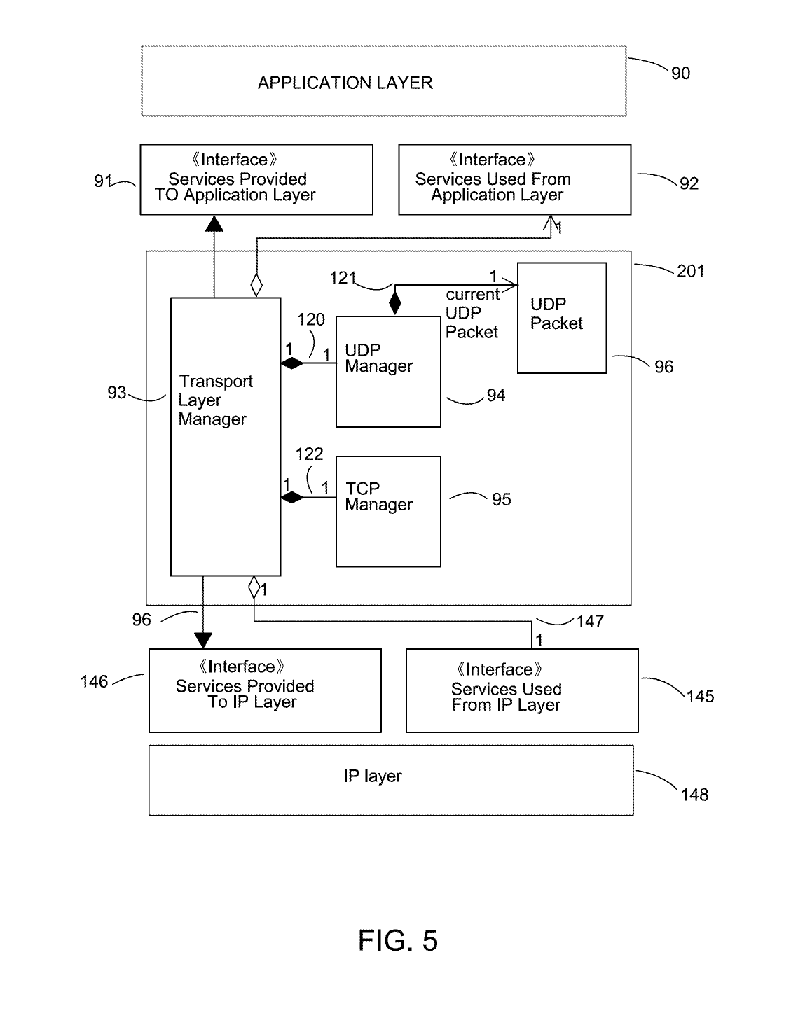

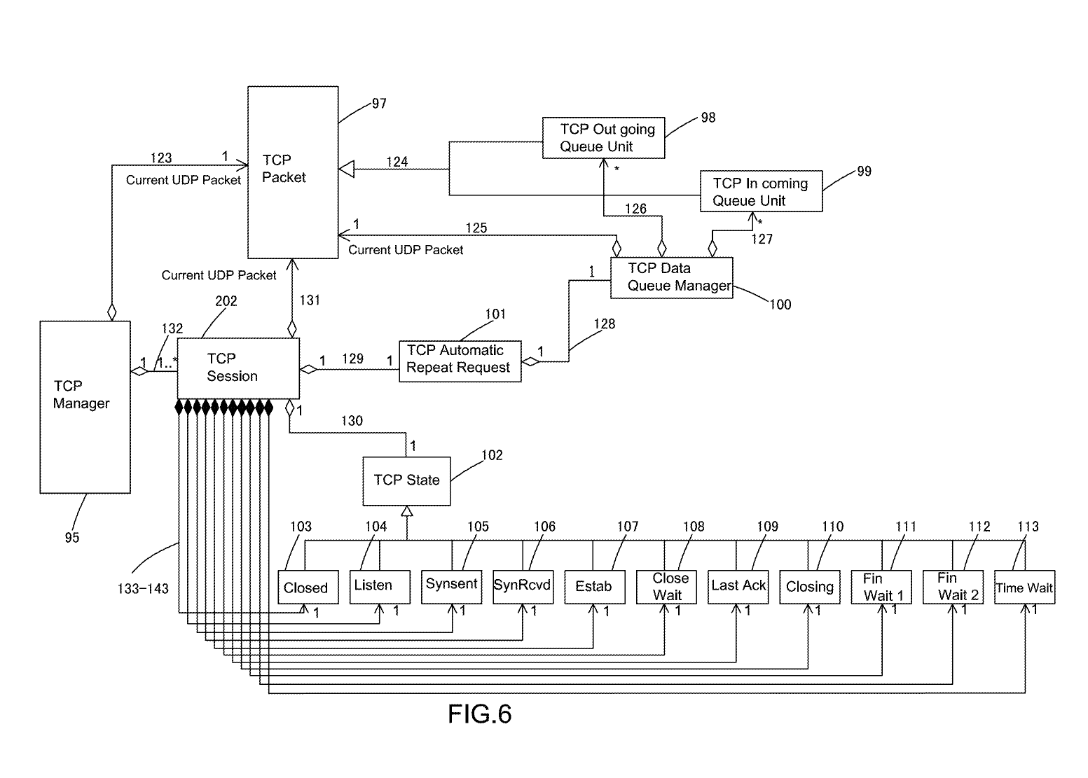

In another embodiment of the invention, the Layer Architecture is applied to the Transport Layer 201 of a network as shown in FIG. 5 and FIG. 6. In this network, Transport Layer 201 is placed between Application Layer 90 and IP Layer 148. In a structure like this, Application Layer 90 is not specified in detail and may be kept generic. Transport Layer 201 comprises Transport Layer Manager 93, UDP Manager 94. TCP Manager 95, UDP Packet Unit 96, TCP Packet Unit 97, TCP Session Unit 202, TCP State Unit 102, TCP Automatic Repeat Request Unit 101, TCP Data Queue Manager 100, TCP Incoming Queue Unit 99 and TCP outgoing Queue Unit 98. Transport Layer Protocol 201 uses two different transport layer protocols, namely. TCP and UDP. Both protocols have their own protocol managers, namely UDP Manager 94 and TCP Manager 95. These two protocols coexist to serve different requirements desired by the Application Layer 90. TCP is a connection oriented, stateful and reliable protocol, while UDP is connectionless, stateless and unreliable.

Transport Layer Manager 93 manages the upper layer (application layer) and lower layer (IP layer) interfaces. It routes the incoming requests or packets from these interfaces to the TCP Manager 95 or UDP Manager 94 according to the type of them. Similarly, it routes request or packets from TCP Manager 95 and UDP Manager 94 to the appropriate interface. LTDP Manager 94 realizes the UDP protocol and uses the UDP Packet Unit 96. UDP Packet Unit 96 processes the UDP protocol packet operations such as pack, parse, control, check, allocate, de-allocate, encapsulate and de-capsulate.

TCP Manager 95 manages all TCP connections by using TCP Packet Unit 97 and TCP Session Units 202 each representing a TCP connection. TCP Packet Unit 97 processes the TCP protocol packet operations such as pack, parse, control, check, allocate, de-allocate, encapsulate and de-capsulate. TCP Session Unit 202 manages the TCP connection by using TCP Automatic Repeat Request Unit 101, TCP Packet Unit 97, TCP State Unit 102 and TCP concrete state units which are generalized from TCP State Unit 102. RFC 793 defines eleven number of TCP connection states which are represented by the concrete state units such as Closed, Listen, SynSent, SynRcvd, Estab, CloseWait, LastAck, Closing, FinWait1, FinWait2, TimeWait. Details of the TCP states can be found in RFC 793. TCP Session Unit 202 processes the TCP State Unit 102 for each triggered event and as a result, TCP state is updated and some action is executed according to the current state. TCP Automatic Repeat Request Unit 101 is responsible for reliable TCP communication. It has TCP Data Queue Manager 100 which manages incoming and outgoing TCP buffers by using TCP Incoming Queue Element Units 99 and TCP Outgoing Queue Element Units 98. TCP Incoming Queue Element Unit 99 and TCP Outgoing Queue Element Unit 98 are generalized from TCP Packet Unit 97 and they process incoming and outgoing TCP buffer operations such as add, delete, find, copy. generate and release.

Because of the nature of TCP, the main class of this protocol. TCP Manager 95 needs a session oriented structure with connection states to be in interaction with itself Firstly, connection oriented nature requires use of un-estimated but platform dependent number of TCP Sessions 202 representing each connection, and secondly, stateful nature of each TCP connection needs a state design pattern consisting, of TCP Session 202 class and generalized state classes connected with each session.

Reliability of the protocol is provided by TCP Automatic Repeat Request 101 which is also using a TCP Data Queue Manager 100 for packet queueing purposes. All TCP packets coming from the lower layer and all application data coming from the upper layer are processed, coded or decoded by the help of TCP Packet class 97 connected. to TCP Manager 95. TCP Packet class 97 is also connected to TCP Session Unit 202 and to TCP Data Queue Manager 100.

In contrast to TCP, UDP is modeled with only UDP Manager class 94 assisted with UDP Packet class 96. Basic role of UDP, and its limited capabilities, let this protocol be modeled as seen in in FIG. 5.

UDP Manager 94 is connected to UDP Packet Unit 96.

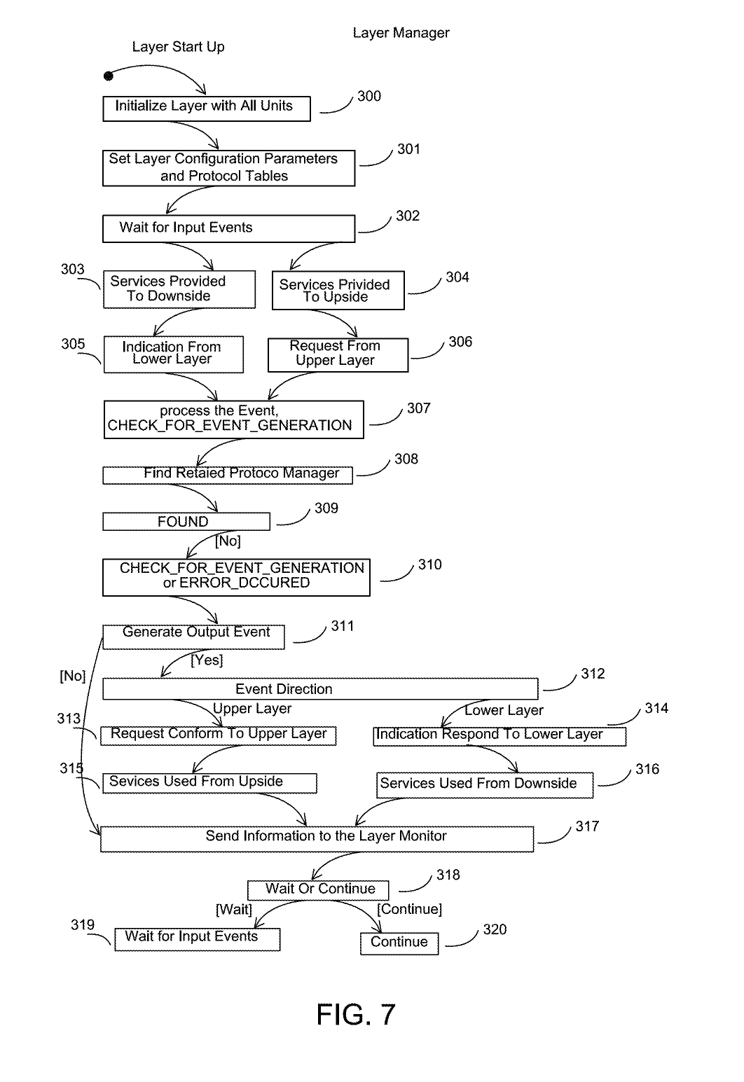

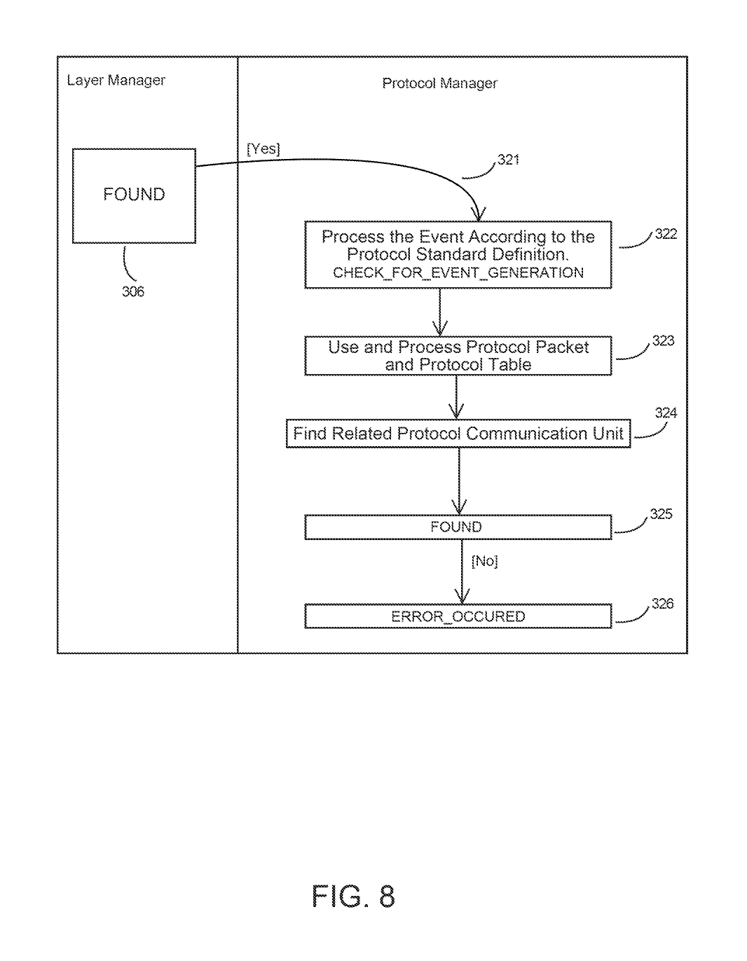

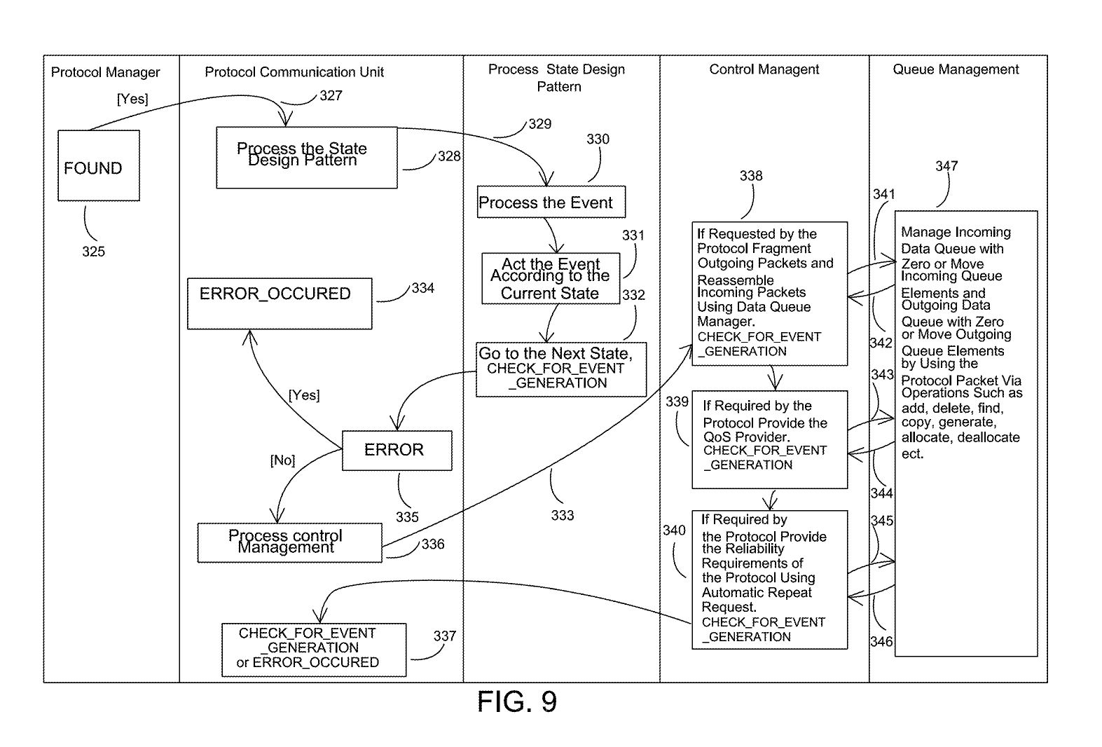

The method for performing the operations of different units within the LA is disclosed in FIG. 7, FIG. 8 and FIG. 9. In this method upon receiving the layer start up signal, Layer Manager 33 initializes all layer units in step 300. In step 301, layer configuration parameters and protocol tables are set up. In step 302, the Layer Manager 33 waits for an input event Depending upon the input, the system progresses to either step 303 or step 304. If the input event requires providing service to down layer then the system moves to step 305. On the other hand if the input requires providing service to upper layer then the system moves to step 304 and then to step 306 to provide service to upper layer. In both cases, the system moves to step 307 where the event is processed. In step 308, the system finds the proper protocol manager based on the input event. If a proper protocol manager is not found then the system progresses to step 310 where the system checks of an event generation or error occurred. In step 311 the system checks if an output event is generated. If an output event is not generated then the system moves to step 317 where the system sends information to Layer Manager. If an output event is generated then the system moves to step 312 where the event is further checked to find out if the event is related to upper layer or lower layer. If the event is related to upper layer then the system moves to step 313 where request from the upper layer is confirmed. Upon this confirmation, the system moves to step 315 where services list used from the upper layer is checked. Upon checking the services, the system moves to step 317 where the information is sent to layer monitor.

If the event is related to a lower layer then the system moves to step 314 where lower layer was notified about the event. Upon this confirmation, the system moves to step 316 where services list used from the lower layer is checked. Upon checking the services, the system moves to step 317 where the information is sent to the layer monitor. After the system sends the information to Layer Monitor 39, the system moves to step 318 to check if the system should wait or continue. If the system has to wait then the system moves to step 319 where the system waits for an input event. If the system moves to step 320 then the system continues its operation.

If during the operation in step 309, if a proper protocol manager found then the system moves to step 322 in which case the event is processed based on the protocol standard definition. In step 323, proper process protocol packet and protocol table are used. In step 324 a related protocol communication unit is searched. If a related protocol communication unit is not found then the system produces an error in step 326 and this error signal is presented to the user to let the user know that there is no proper communication unit in this system to handle the incoming event that requires a specific communication unit.

If in step 325 a proper protocol communication unit is found then the system moves to step 328 where the state design pattern is processed in the protocol communication unit. After the process of the state design protocol, the system moves to step 330 where the event is processed. After the process, the system performs the event requirement according to the current state. Afterwards the system moves to step 332 where the system goes to the next state. In step 335 the system checks if there is any error. If there is an error then the system moves to step 334 where the system stops and reports the error.

If in step 335 there is no error then the system moves to step 336 for process.

control management. In step 338, if required, the system fragments outgoing packets and reassembles incoming packets using Data Queue Manager. The system moves to step 339 if it is required by the protocol to provide QoS services. Afterwards, if it is required by the protocol, the system moves to step 340 to provide reliability requirements. The system manages steps 338, 339 and 340 with the help from step 347 where incoming queue and outgoing queue are managed by one or more Incoming Queue element and Outgoing Queue Element. The system uses Protocol Packet for operations such as add, delete, copy, generate, allocate and de-allocate.

While the foregoing written description of the invention enables one of ordinary Skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

I claim:

1. A non-transitory computer-readable medium having embodied thereon a computer program configured to cause a processor to communicate between two endpoints connected to a network,
the non-transitory computer-readable medium comprising one or more code segments configured the processor to:
have a first layer to send information to a communication layer identifying services provided to the communication layer;
have a second layer to send information to a communication layer identifying services provided to the communication layer;
have a layer manager unit in the communication layer to send information to a layer configuration parameters unit;
have the layer manager unit in the communication unit to receive information from a protocol manager;
have the layer manager unit to send information to a layer monitor unit; and
have the layer manager to send information to the second layer.

2. The non-transitory computer-readable medium of claim 1 wherein the one or more code segments are further configured to cause a processor to:
have the protocol manager unit send information to a protocol packet unit;
have the protocol packet unit send information to a protocol communication unit;
have the protocol manager unit and the protocol communication unit send information to a protocol table unit.

3. The non-transitory computer-readable medium of claim 2 wherein the one or more code segments are further configured to cause a processor to:
have an incoming queue element unit send information to the protocol packet unit;
have an outgoing queue element unit send information to the protocol packet unit;
have a data queue manager send information to the incoming queue element unit; and
have the data queue manager unit send information to the outgoing queue element unit.
have the data queue manager unit send information to the protocol packet unit.

4. The non-transitory computer-readable medium of claim 1 wherein the one or more code segments are further configured to cause a processor to:
have a fragmented reassembly unit send reassembled packets to data queue manager unit;
have qos provider unit send packets to data queue manager unit;
have automatic repeat request unit send packets to the data queue manager.

5. The non-transitory computer-readable medium of claim 1 wherein the one or more code segments are further configured to cause a processor to:
have a fragmented reassembly unit send reassembled packets to the protocol communication unit;
have qos provider unit send packets to the protocol communication unit;
have automatic repeat request unit send packets to the protocol communication unit; and
wherein the protocol communication unit processes the protocol using states and processes the ARQ, F/R or QoS mechanisms if needed.

6. The non-transitory computer-readable medium of claim 1 wherein the one or more code segments are further configured to cause a processor to:
have a state unit send information to the protocol communication unit; and
have the protocol communication unit send information to a concrete state unit.

7. The non-transitory computer-readable medium of claim 1 wherein the one or more code segments are further configured to cause a processor to:
have the protocol manager unit send information to a layer monitor unit.

8. The non-transitory computer-readable medium of claim 1 wherein the one or more code segments are further configured to cause a processor to:
Have the layer manager unit send information to a service provided to upside unit;
have the layer manager unit send information to a services used from upside unit;
wherein the current layer can get the information about the services provided from upside unit by reading the information in the services provided from upside unit; and
wherein the next layer can get the information about services provided by the current layer by accessing the information in the services provided to upside unit.

9. The non-transitory computer-readable medium of claim 1 wherein the one or more code segments are further configured to cause a processor to:
have the layer manager unit send information to a service provided to downside unit;
have the layer manager unit send information to a services used from upside unit;
wherein the layer manager unit can send information about the services provided to downside unit by sending the information to the services provided to downside unit; and
wherein the layer manager unit can receive information about the services used from downside unit by receiving the information from the services used from downside unit.

10. A non-transitory computer-readable medium having embodied thereon a computer program configured to cause a processor to communicate between two endpoints connected to a network,
the non-transitory computer-readable medium comprising one or more code segments configured the processor to:
have a first layer to send information to a communication layer identifying services provided to the communication layer;
have a second layer to send information o a communication layer identifying services provided to the communication layer;
have a TCP manager unit send information to a TCP packet unit;
have transport layer manager send information to UDP manager;
have UDP manager unit send information to the transport layer manager; and
have the TCP manager send information to the transport layer manager.

11. The non-transitory computer-readable medium of claim 10 wherein the one or more code segments are further configured to cause a processor to:
have the UDP manager send information to UDP packet unit;
have TCP session unit send information to TCP manager unit.

12. The non-transitory computer-readable medium of claim 10 wherein the one or more code segments are further configured to cause a processor to:
have TCP outgoing queue element send information to TCP packet unit;
have TCP incoming queue element send information to the TCP packet unit;
have TCP data queue manager unit, send information to the TCP incoming queue. unit;
have TCP data queue manager send information to the TCP outgoing queue unit;
have TCP outgoing queue unit send information to TCP packet unit; and
have TCP incoming queue unit send information to the TCP packet unit,

13. The non-transitory computer-readable medium of claim 10 wherein the one or more code segments are further configured to cause a processor to:
have TCP data queue manager unit send information to a TCP automatic repeat request unit;
have the TCP automatic repeat request unit send information to the TCP session unit; and
have a TCP state unit send information to the TCP session unit.

14. The non-transitory computer-readable medium of claim 10 wherein the one or more code segments are further configured to cause a processor to:
have a closed unit send information to the TCP session unit;
have a listen unit send information to the TCP session unit;
have a synsent unit send information to the TCP session unit:
have a synrcvd unit send information to the TCP session unit;
have a estab unit send information to the TCP session unit;
have a close wait unit send information to the TCT session unit;
have a lastack unit send information to the TCP session unit;
have a closing unit send information to the TCP session unit;
have a finwait1 unit send information to the TCP session unit;
have a finwait2 unit send information to the TCP session unit;
have a timewait unit send information to the TCP session unit;

15. The non-transitory computer-readable medium of claim 10 wherein the one or more code segments are further configured to cause a processor to:
have the transport layer manager unit send information to a services provided to application layer unit;
have the transport layer manager unit send information to a services used from application layer unit;
wherein the transport layer can get the information about the services provided from upside unit by reading the information in the services provided from the application layer unit; and
wherein the application layer can get the information about services provided by the transport layer by accessing the information in the services provided to application layer unit.

16. The non-transitory computer-readable medium of claim 1 wherein the one or more code segments are further configured to cause a processor to:
have the transport layer manager unit send information to a services provided to IP layer unit;
have the transport layer manager unit send information to a services used from IP layer unit;
wherein the transport layer manager unit can send information about the services. provided to IP layer by sending the information to the services provided to IP layer unit; and
wherein the transport layer manager unit can receive information about the services used from the IP layer unit by receiving the information from the services used from IP layer unit.

17. A method of communicating between two endpoints connected to a network, the method comprising the steps of:
initializing a current layer units;
configuring parameters and layer protocol tables;
waiting for an input event;
providing service to a lower layer if the input indicates that the lower layer requires a service from the current layer;
providing service to an upper layer if the upper layer requires a service from the current layer;
processing the input event;
searching for a proper protocol manager based on the input event.

18. The method of claim 17 further comprising:
checking, for an event generation or error condition if a proper protocol manager is not located;
checking, if an output event is generated;
sending, information to layer manager if an output event is not generated:
checking, to find out if the event is an upper layer event or a lower layer event if an output event is generated;
confirming a request from the upper layer if the request is from the upper layer;
checking the service list from the upper layer if the request is from the upper layer.

19. The method of claim 18 further comprising:
notifying the lower layer if the event is a lower layer event;
checking the services list from the lower layer if the event is a lower layer event;
sending information to the layer monitor;
checking to find out if the system should wait or continue;
waiting for an input event if the command is to wait;
continuing the operation if the command is to continue.

20. The method of claim 17 further comprising:
processing the event based on a standard protocol definition if a proper protocol manager is found;
using proper protocol packet and protocol table;
searching for a related protocol communication unit.

21. The method of claim 20 further comprising:
generating an error if a related protocol communication unit is not found.

22. The method of claim 20 further comprising:
processing the state design pattern if a related protocol communication unit is found;
processing the event;
performing the event requirement according to the current state;
checking to find out if there is any error.

23. The method of claim 22 further comprising:
stopping the operation and reporting the error if there is an error.

24. The method of claim 22 further comprising:
fragmenting outgoing packets if there is no error and if the system requires fragmentation;
reassembling incoming packets is there is no error and if the system requires reassembling;
providing quality of services if there is no error and if the system requires quality of services.
